(19) United States
(12) Patent Application Publication
(10) Pub. No.: US 2018/0367836 A1
(43) Pub. Date: Dec. 20, 2018

(54) A SYSTEM AND METHOD FOR CONTROLLING MIRACAST CONTENT WITH HAND GESTURES AND AUDIO COMMANDS

(71) Applicant: SMARTRON INDIA PRIVATE LIMITED, Hyderabad (IN)

(72) Inventor: SHRENIK SARJERAO SHIKHARE, Kolhapur (IN)

(21) Appl. No.: 16/061,152

(22) PCT Filed: Dec. 8, 2016
(86) PCT No.: PCT/IN2016/000286

§ 371 Date: Jun. 11, 2018

(30) Foreign Application Priority Data
Dec. 9, 2015 (IN) 4768/CHE/2015

(51) Int. Cl. H04N 21/422; G06F 3/01; H04N 21/4223; H04N 21/4363

(52) U.S. Cl. CPC H04N 21/4222; H04N 21/42203; H04N 21/43637; H04N 21/4223; G06F 3/017

(57) ABSTRACT

The embodiments herein provide a system and method for enhancing a user experience by controlling a Miracast content with user gestures and audio commands using a mobile device such as a smart phone. The system comprises a Television (TV) broadcast application installed in a mobile device to capture the hand gestures and audio commands from a user through a camera and an audio input system in the mobile device. A hand gesture and voice recognition processor in the mobile device processes the hand gesture and audio commands into a usable format. A Miracast wireless display sub system broadcasts the display signals wirelessly to a Miracast receiver installed inside the TV. The Miracast receiver in the TV receives the signals and mirrors the content of the mobile device display on the TV screen.

### CROSS REFERENCE TO RELATED APPLICATIONS

This patent application is a National Phase Application corresponding to the PCT Application No. PCT/IN2016/000286 filed on Dec. 8, 2016 with the title “A SYSTEM AND METHOD FOR CONTROLLING MIRACAST CONTENT WITH HAND GESTURES AND AUDIO COMMANDS”. This patent application claims the priority of the Indian Provisional Patent Application No. 4768/CHE/2015 filed on Dec. 9, 2015 with the title “A SYSTEM AND METHOD FOR CONTROLLING MIRACAST CONTENT WITH HAND GESTURES AND AUDIO COMMANDS”, the contents of which is included herein by the way of reference.

### BACKGROUND

### Technical Field

The embodiments herein are generally related to the field of electronic devices and display of contents in the electronic devices. The embodiments herein are particularly related to a system and method for mirroring a display content on a mobile device to an ordinary TV screen using a wireless display standard (Miracast). The embodiments herein are more particularly related to a system and method for a system and method for enhancing user experience by controlling Miracast content with hand gestures and audio commands through a mobile device.

### DESCRIPTION OF THE RELATED ART

People face challenges while viewing the web pages, images, and other media content on small devices such as mobile phones, tablets, and personal digital assistants (“PDAs”). These devices have a very small display area to display the desired content. For example, the mobile devices use a web browser to display the standard size web pages. When a web page with a high resolution image is displayed in a small display area, the web page image is displayed in a much lower resolution to fit the entire display page. As a result, the user is not able to clearly see and comprehend the details of the displayed page. Alternatively, only a small portion of the display page is shown at a time, when the web page image is displayed in full resolution in a small display area. To view other portions of the web page, the user needs to navigate by scrolling and zooming into particular portions of the web page. Hence, many users of the small devices use a large display screen such as a TV screen while accessing the web pages, images, and media content on the mobile devices.

On the other hand, with rapid development of digital TV transmission technology, advancements for smart televisions have been made dramatically in this field. Compared to the ordinary television sets, smart televisions are highly priced but are designed to provide a higher degree of comfort and convenience to the user. Due to high cost, many of the small screen users are not interested and are unable to buy the smart television. The existing ordinary or old televisions do not have the inbuilt broadcasting feature. As a result, the small screen users are unable to access the mobile content on ordinary TV screens.

In the existing wireless display broadcasting systems, the user needs to hold the mobile device in hand and provide a direct touch inputs on the screen of the mobile device while broadcasting the content to the smart TV. Even though direct touch interaction is clearly intuitive and popular, it has some drawbacks. In particular, as the mobile devices continue to be miniaturized, size of touchscreen becomes increasingly limited. This leads to smaller on-screen targets and fingers causing occlusions of displayed content. For example, the direct touch interactions does not work or are practically impossible due to a limited size of the mobile screen during prolonged interactions or reading web pages on a mobile device or attempting to perform complex manipulations.

Hence there is a need for a system and method for enhancing a user experience by controlling a display content such as Miracast content with hand gestures and audio commands through a mobile computing device such as a smart phone. There is also a need for a system and method for mirroring a mobile device display on an ordinary TV screen using hand gestures and audio commands of a user. Further, there is also a need for a system and method that allows the user to provide touch less user inputs while operating a mobile computing device.

The above mentioned shortcomings, disadvantages and problems are addressed herein and which will be understood by reading and studying the following specification.

### Objects of the Embodiments Herein

The primary object of the embodiment herein is to provide a system and method for enhancing a user experience by controlling a display content such as Miracast content with user gestures and audio commands through a mobile computing device such as a smart phone.

Another object of the embodiment herein is to a system and method for mirroring a mobile device display on an ordinary TV screen using hand gestures and audio commands of a user.

Yet another object of the embodiment herein is to provide a system and method that allows the user to provide touch less user inputs while operating a mobile computing device.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The various embodiments of the embodiment herein provide a system and method for enhancing a user experience by controlling the display content such as Miracast content based on the user gestures and audio commands through a mobile device such as a smart phone. The system comprises a TV broadcast app, and a Television (TV). The TV broadcast is installed in a user mobile device. The mobile device further comprises a camera, an audio input system, a mobile processor and a wireless display sub system, such as Miracast wireless display subsystem.

According to an embodiment herein, the mobile device (source device) is a mobile or handheld PC, or a tablet or smart phone, or a feature phone, or a smart watch, or any other similar device.

According to an embodiment herein, a method for controlling display content such as a Miracast content on a sink device is provided. The method involves/comprises establishing a wireless connection with a source device and a sink device. Further, a first mirror video from the source device is transmitted through the wireless connection. The transmitted first mirror video is received by the sink device through the wireless connection. Inputs are received from a user through a gesture recognition module in the source device. The received inputs are mapped to a control command of the source device. The input comprises gestures and audio commands. Thus, a second video content is provided in the source device based on the control command. The second video content is received in the sink device based on the control command.

According to an embodiment herein, the step of mapping received inputs to a control command of the source device comprises detecting gestures in the input with a the gesture recognition module, and decoding the detected gestures to generate control commands. Further, the method includes capturing an audio with an audio capturing module, performing noise filtering on the audio command, and processing the audio to extract audio commands. The step of detecting gestures in the input with the gesture recognition module comprises detecting gesture inputs with a computer vision module or motion picture module in the mobile computing device (mobile phone) or computing to detect at least one of skin color, hand shape, edges detection and motion tracking. The step of detecting an audio command with an audio capturing module comprises processing the audio using any one of digital filtering, and Fourier transform to extract audio data. Further, the audio data is decoded to detect audio commands by mapping the audio data with a speech recognition model.

According to an embodiment herein, a system for controlling Mira cast content on a sink device is provided. The system comprises transmitting a first mirror video from a source device through a wired/wireless communication process. The source device comprises a hardware processor coupled to a memory containing instructions configured for controlling Mira cast content through gestures and audio inputs. The system includes a sink device coupled to the source device through the wireless network. The sink device receives the first mirror video from the source device. The system includes a camera coupled to the source device to capture gestures provided by a user. The system includes an audio input coupled to the source device to capture audio provided by the user.

According to an embodiment herein, a computer implemented method comprising instructions stored on a non-transitory computer readable storage medium memory and run on a computing system provided with a hardware processor and a memory for controlling a display content such as Miracast content on a sink device, is provided. The method involves/comprises establishing a wireless connection with a source device and a sink device. Further, a first mirror video from the source device is transmitted through the wireless connection. The transmitted first mirror video is received by the sink device through the wireless connection. Inputs are received from a user through a gesture recognition module in the source device. The received inputs are mapped to a control command of the source device. The input comprises gestures and audio commands. Thus, a second video content is provided in the source device based on the control command. The second video content is received in the sink device based on the control command.

According to an embodiment herein, the step of mapping received inputs to a control command of the source device comprises detecting gestures in the input with a the gesture recognition module, and decoding the detected gestures to generate control commands. Further, the method includes capturing an audio with an audio capturing module, performing noise filtering on the audio command, and processing the audio to extract audio commands. The step of detecting gestures in the input with the gesture recognition module comprises detecting gesture inputs with a computer vision module or motion picture module in the mobile computing device (mobile phone) or computing to detect at least one of skin color, hand shape, edges detection and motion tracking. The step of detecting an audio command with an audio capturing module comprises processing the audio using any one of digital filtering, and Fourier transform to extract audio data. Further, the audio data is decoded to detect audio commands by mapping the audio data with a speech recognition model.

According to an embodiment herein, the TV broadcast application is configured to capture the hand gestures from the user through the camera installed in the mobile device. Similarly, the TV broadcast application is configured to capture the audio commands from the user through the audio input system installed in the mobile device. The TV broadcast application further comprises a hand gesture and voice recognition processor that is configured to recognize and process the captured hand gestures and audio commands into a usable format. The hand gesture and voice recognition processor is further configured to send the processed signals to the mobile processor. The mobile processor is configured to instruct the wireless display sub system such as Miracast to broadcast the processed hand gestures and audio commands to the TV.

According to an embodiment herein, the TV comprises an inbuilt wireless display such as Miracast functionality that receives the wireless display signals sent by the Miracast wireless display sub system in the mobile device.

According to an embodiment herein, the Miracast functionality is externally added to the TV by connecting a Miracast dongle to the TV.

Initially, the camera and the audio input unit of the mobile device captures hand gesture and audio commands from the user. The captured hand gesture and audio commands are sent to the hand gesture and voice recognition processor. The hand gesture and voice recognition processor in the mobile device recognizes the commands and further process the commands into a usable format. After processing, the hand gesture and voice recognition processor sends the commands to the mobile processor. The mobile processor forwards the commands to a wireless display sub system such as Miracast wireless display sub system. Further, the display control system such as Miracast controlling system sends commands to the Miracast wireless display sub system and performs an action based on the gesture and voice commands provided by the user. The wireless receiver such as Miracast receiver present in the TV mirrors the content of the mobile device display on the TV screen. Thus, the mobile content is mirrored to an ordinary TV without providing touch inputs to the mobile device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1 illustrates a functional block diagram of a wireless display such as Miracast controlling system, according to an embodiment herein.

FIG. 2 illustrates a flowchart explaining a method for enhancing user experience by controlling wireless display content such as Miracast content with user gestures and audio commands through a mobile computing device, according to an embodiment herein.

Although the specific features of the present invention are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments of the embodiment herein provide a system and method for enhancing a user experience by controlling the display content such as Miracast content based on the user gestures and audio commands through a mobile device such as a smart phone. The system comprises a TV broadcast app, and a Television (TV). The TV broadcast is installed in a user mobile device. The mobile device further comprises a camera, an audio input system, a mobile processor and a Miracast wireless display sub system.

According to an embodiment herein, the mobile device (source device) is a mobile or handheld PC, or a tablet or smart phone, or a feature phone, or a smart watch, or any other similar device.

According to an embodiment herein, a method for controlling display content such as Miracast content on a sink device is provided. The method involves/comprises establishing a wireless connection with a source device and a sink device. Further, a first mirror video from the source device is transmitted through the wireless connection. The transmitted first mirror video is received by the sink device through the wireless connection. Inputs are received from a user through a gesture recognition module in the source device. The received inputs are mapped to a control command of the source device. The input comprises gestures and audio commands. Thus, a second video content is provided in the source device based on the control command. The second video content is received in the sink device based on the control command.

According to an embodiment herein, the step of mapping received inputs to a control command of the source device comprises detecting gestures in the input with a the gesture recognition module, and decoding the detected gestures to generate control commands. Further, the method includes capturing an audio input with an audio capturing module, performing noise filtering on the audio input, and processing the audio input to extract audio commands. The step of detecting gestures in the input with the gesture recognition module comprises detecting gesture inputs with a computer vision module or motion picture module in the mobile computing device (mobile phone) or computing to detect at least one of skin color, hand shape, edges detection and motion tracking. The step of detecting an audio command with an audio capturing module comprises processing the audio using any one of digital filtering, and Fourier transform to extract audio data. Further, the audio data is decoded to detect audio commands by mapping the audio data with a speech recognition model.

According to an embodiment herein, a system for controlling display content such as Mira cast content on a sink device is provided. The system comprises transmitting a first mirror video from a source device through a wired/wireless communication process. The source device comprises a hardware processor coupled to a memory containing instructions configured for controlling Mira cast content through gestures and audio inputs. The system includes a sink device coupled to the source device through the wireless network. The sink device receives the first mirror video from the source device. The system includes a camera coupled to the source device to capture gestures provided by a user. The system includes an audio input coupled to the source device to capture audio provided by the user.

According to an embodiment herein, a computer implemented method is provided for controlling display content such as Miracast content on a sink device. The computer implemented method comprises instructions stored on a non-transitory computer readable storage medium and run on a mobile computing system provided with a hardware processor and the memory for controlling display content such as Miracast content on a sink device. The method involves/comprises establishing a wireless connection with a source device and a sink device. Further, a first mirror video from the source device is transmitted through the wireless connection. The transmitted first mirror video is received by the sink device through the wireless connection. Inputs are received from a user through a gesture recognition module in the source device. The received inputs are mapped to a control command of the source device. The input comprises gestures and audio commands. Thus, a second video content is provided in the source device based on the control command. The second video content is received in the sink device based on the control command.

According to an embodiment herein, the step of mapping received inputs to a control command of the source device comprises detecting gestures in the input with a the gesture recognition module, and decoding the detected gestures to generate control commands. Further, the method includes capturing an audio with an audio capturing module, performing noise filtering on the audio command, and processing the audio to extract audio commands. The step of detecting gestures in the input with the gesture recognition module comprises detecting gesture inputs with a computer vision module or motion picture module in the mobile computing device (mobile phone) or computing to detect at least one of skin color, hand shape, edges detection and motion tracking. The step of detecting an audio command with an audio capturing module comprises processing the audio using any one of digital filtering, and Fourier transform to extract audio data. Further, the audio data is decoded to detect audio commands by mapping the audio data with a speech recognition model.

According to an embodiment herein, the mobile device is a mobile or handheld PC, or a tablet or smart phone, or a feature phone, or a smart watch, or any other similar device.

According to an embodiment herein, the TV broadcast application is configured to capture the hand gestures from the user through the camera installed in the mobile device. Similarly, the TV broadcast application is configured to capture the audio commands from the user through the audio input system installed in the mobile device. The TV broadcast application further comprises a hand gesture and voice recognition processor that is configured to recognize and process the captured hand gestures and audio commands into a usable format. The hand gesture and voice recognition processor is further configured to send the processed signals to the mobile processor. The mobile processor is configured to instruct the Miracast wireless display sub system to broadcast the processed hand gestures and audio commands to the TV.

According to an embodiment herein, the TV comprises an inbuilt display or Miracast functionality that receives the wireless display signals sent by the wireless display sub system such as Miracast wireless display sub system in the mobile device.

According to an embodiment herein, the display functionality such as Miracast functionality is externally added to the TV by connecting a Miracast dongle to the TV.

Initially, the camera and the audio input unit of the mobile device captures the hand gesture and audio commands from the user. The captured hand gesture and audio commands are sent to the hand gesture and voice recognition processor. The hand gesture and voice recognition processor in the mobile device recognizes the commands and further process the commands into a usable format. After processing, the hand gesture and voice recognition processor forwards the commands to the mobile processor. The mobile processor forwards the commands to a Miracast wireless display sub system. Further, the Miracast controlling system sends the commands to the Miracast wireless display sub system and performs an action based on the gesture and voice commands provided by the user. The Miracast receiver present in the TV mirrors the content of the mobile phone display on the TV screen. Thus, the mobile content is mirrored to an ordinary TV without providing touch inputs to the mobile device.

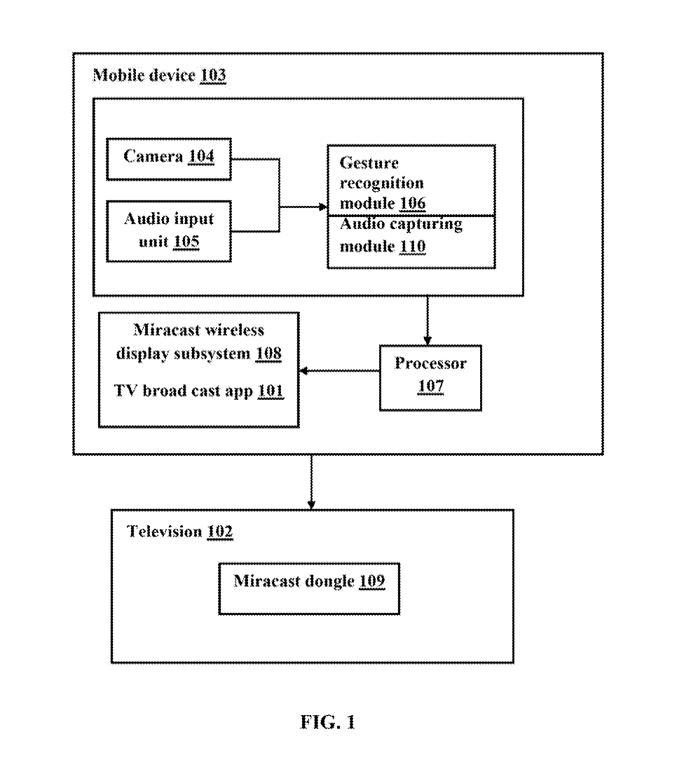

FIG. 1 illustrates a block diagram of a dynamic display switching system, according to an embodiment herein. With respect to FIG. 1, the system comprises the TV broadcast application 101, and Television (TV) 102. The TV broadcast application is installed in a mobile device 103. The mobile device (source device) 103 further comprises camera 104, audio input system 105, processor 106 and Miracast wireless display sub system (sink device) 107. The mobile device 103 functions as the source device and the Mira cast wireless display sub system 107 functions as the sink device.

According to an embodiment herein, the mobile device 103 is a mobile or handheld PC, or a tablet or smart phone, or a feature phone, or a smart watch, or any other similar device.

According to an embodiment herein, the TV broadcast application 101 is configured to capture the hand gestures from the user through the camera 104 installed in the mobile device 103. Similarly, the TV broadcast application 101 is configured to capture the audio commands from the user through the audio input system 105 installed in the mobile device 103. The mobile device 103 further comprises gesture recognition module 106 and audio capturing module 110 that is configured to recognize and process the captured hand gestures and audio inputs into control commands. The step of mapping received inputs (hand gestures and audio inputs) to the control command of the source device includes detecting gestures in the input by the gesture recognition module 106. Further, the gestures are decoded to generate control commands. An audio input is captured by an audio capturing module 110. Further, noise filtering is performed on the audio input; and the audio input is processed to extract audio commands. The step of detecting gestures in the input by the gesture recognition module 106 comprises detecting gestures through a computer vision module to detect at least one of skin color, hand shape, edges detection and motion tracking. The computer vision module is configured to acquire, process, analyze and understand digital images captured by the camera 104. The step of processing the audio input to extract audio commands by the audio capturing module 110 includes processing the audio input using any one of digital filtering, and Fourier transform techniques to extract the audio data. Further, the audio capturing module 110 is configured to map the audio data with a speech recognition model to decode audio commands.

According to an embodiment herein, the control commands and audio commands is sent to the processor 107. Thus, a first video content in the mobile device is replaced with a second video content based on the control signals (including control commands and audio command). Further, the second video content is displayed in the television 102 (sink device) based on the control command.

The processor 107 is configured to instruct the Miracast wireless display sub system 108 to broadcast content based on the processed hand gestures and audio commands.

According to an embodiment herein, the TV 102 comprises the inbuilt Miracast functionality 109 that receives the wireless display signals sent by the Miracast wireless display sub system 108 in the mobile device 103.

According to an embodiment herein, the Miracast functionality is externally added to the TV 102 by connecting Miracast dongle 109 to the TV 102.

According to an embodiment herein, a system for controlling Mira cast content on a sink device is provided. The system comprises transmitting a first mirror video from a source device through a wired/wireless communication process. The source device comprises a hardware processor coupled to a memory containing instructions configured for controlling Mira cast content through gestures and audio inputs. The system includes a sink device coupled to the source device through the wireless network. The sink device receives the first mirror video from the source device. The system includes a camera coupled to the source device to capture gestures provided by a user. The system includes an audio input unit coupled to the source device to capture audio input provided by the user.

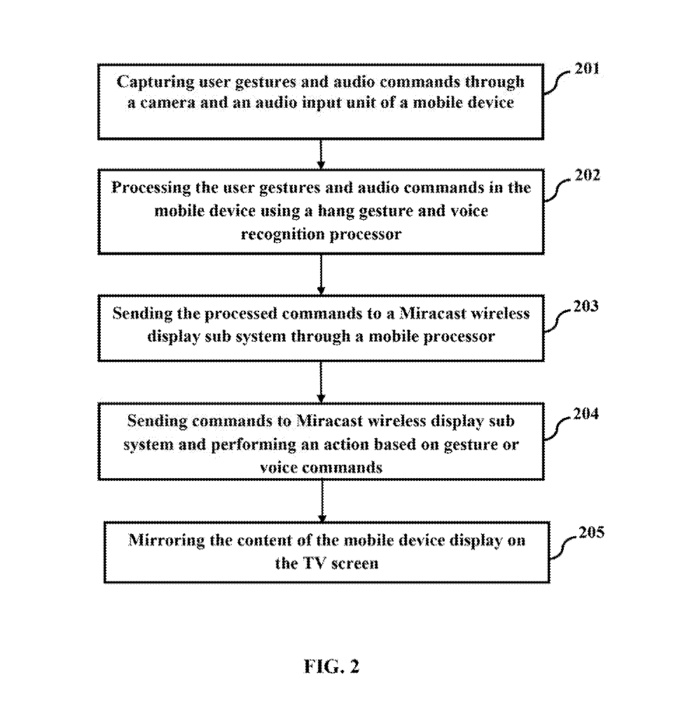

FIG. 2 illustrates a flow chart explaining a method for enhancing user experience by controlling a Miracast content with user gestures and audio commands using a mobile device such as a smart phone, according to an embodiment herein.

According to an embodiment herein, a method for controlling Mira cast content on a sink device includes establishing a wireless connection with a source device and a sink device. Further, a first mirror video from the source device is transmitted through the wireless connection. A first mirror video is received by the sink device through the wireless connection. Inputs are received from a user by a gesture recognition module in the source device and received inputs are mapped to a control command of the source device. The input comprises gestures and audio commands. Thus, a second video content is provided in the source device based on the control command. A second video content is received in the sink device based on the control command.

According to an embodiment herein, the step of mapping received inputs to a control command of the source device includes detecting gestures in the input data by the gesture recognition module, and decoding gestures to generate control commands. Further, the method includes capturing an audio by an audio capturing module, performing noise filtering on the audio command, and processing the audio to extract audio commands. The step of detecting gestures in the input by the gesture recognition module comprises detecting gestures using computer vision module or camera or motion picture module to detect at least on of skin color, hand shape, edges detection and motion tracking. The step of detecting an audio command by an audio capturing module comprises processing the audio using one of digital filtering, and Fourier transform to extract audio data. Further, decoding the audio data to detect audio commands by mapping with a speech recognition model. The motion picture module comprises a camera and an algorithm

According to an embodiment herein, a system for controlling display content such as Mira cast content on a sink device includes a source device for transmitting a first mirror video through a wireless connection. The source device comprises a hardware processor coupled to a memory containing instructions configured for controlling display content such as Mira cast content through gestures and audio inputs. The system includes a sink device coupled to the source device through the wireless network. The sink device receives the first mirror video from the source device. The system includes a camera coupled to the source device to capture gestures provided by a user. The system includes an audio input coupled to the source device to capture audio provided by the user.

According to an embodiment herein, a camera and an audio input unit installed in the mobile device captures the hand gestures and audio commands from the user (201). The captured hand gestures and audio commands are sent to the hand gesture and voice recognition processor. The hand gesture and voice recognition processor in the mobile device is configured to recognize the commands and further process the commands into a usable format (202). After processing, the hand gesture and voice recognition processor forwards the commands to the mobile processor. The mobile processor forwards the commands to a Miracast wireless display sub system (203). Further, the Miracast controlling system sends commands to the Miracast wireless display sub system and performs an action based on the gesture and voice commands provided by the user (204). The Miracast receiver present in the TV mirrors the content of the mobile phone display on the TV screen (205). Thus, the mobile content is mirrored in an ordinary TV screen without providing direct touch inputs to the mobile device.

Therefore, the embodiments herein provide a Miracast controlling system that allows a user to mirror a mobile content in an ordinary TV screen using a mobile device such as a smart phone. The user provides the hand gestures or audio commands to the mobile device for operating the display in an ordinary TV screen. This enhances the user experience while using the mobile device for mirroring the mobile content on big screens.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be the to fall there between.

What is claimed is:

1. A method for controlling display content on a sink device, the method comprising the steps of:
establishing a wireless connection with a source device and a sink device;
transmitting a first mirror video from the source device through the wireless connection;
receiving a first mirror video by the sink device through the wireless connection;
receiving inputs from a user by a gesture recognition module in the source device;
mapping the received inputs to a control command of the source device, and wherein the input comprises gestures and audio commands;
providing a second video content on the source device based on the control command; and
displaying the second video content on the sink device based on the control command.

2. The method as claimed in claim 1 wherein the step of mapping received inputs to a control command of the source device comprises:
detecting gestures in the input by the gesture recognition module;
decoding gestures to generate control commands;
capturing an audio input by an audio input unit;
performing noise filtering on the audio input by an audio capturing module; and
processing the audio input to extract audio commands by the audio capturing module.

3. The method as claimed in claim 2, wherein step of detecting gestures in the input by the gesture recognition module comprises detecting gestures through a computer vision module to detect at least one of skin color, hand shape, edges detection and motion tracking, wherein the computer vision module is configured to acquire, process, analyze and understand digital images captured by a camera.

4. The method as claimed in claim 2, wherein the step of processing the audio input to extract audio commands by the audio capturing module comprises:
processing the audio input using any one of digital filtering, and Fourier transform techniques to extract the audio data; and
mapping the audio data with a speech recognition model to decode audio commands.

5. A system for controlling display content on a sink device, the system comprises:
a source device transmitting a first mirror video through a wireless communication module or device, wherein the source device comprises a hardware processor coupled to a memory stored with instructions configured for controlling Miracast content through gestures and audio inputs;
a sink device coupled to the source device through the wireless network, and wherein the sink device receives the first mirror video from the source device;
a camera coupled to the source device to capture gestures provided by a user; and
an audio input unit coupled to the source device to capture audio inputs provided by the user.

6. The system as claimed in claim 6, wherein the hardware processor comprises a gesture recognition module and an audio capturing module.

7. A computer implemented method comprising instructions stored a non-transitory computer readable storage medium and executed on a computing system provided with a processor and memory or controlling display content or Mira cast content on a sink device, the method comprises:
establishing a wireless connection with a source device and a sink device;
transmitting a first mirror video from the source device through the wireless connection;
receiving a first mirror video by the sink device through the wireless connection;
receiving inputs from a user by a gesture recognition module in the source device;
mapping received inputs to a control command of the source device, and wherein the input comprises gestures and audio commands;
providing a second video content in the source device based on the control command; and
receiving a second video content in the sink device based on the control command.

8. The method as claimed in claim 7, wherein the step of mapping received inputs to a control command of the source device comprises:
detecting gestures in the input by the gesture recognition module;
decoding gestures to generate control commands;
capturing an audio by an audio capturing module;
performing noise filtering on the audio command; and
processing the audio to extract audio commands.

9. The method as claimed in claim 8, wherein step of detecting gestures in the input by the gesture recognition module comprises detecting gestures through computer vision module or motion picture module to detect at least one of skin color, hand shape, edges detection and motion tracking.

10. The method as claimed in claim 8, wherein the step of detecting an audio command by an audio capturing module comprises:
processing the audio using any one of digital filtering, and Fourier transform techniques to extract the audio data; and
decoding the audio data to detect audio commands by mapping the audio commands with a speech recognition model.
